(19) United States
(12) Patent Application Publication
(10) Pub. No.: US 2007/0081448 A1
(43) Pub. Date: Apr. 12, 2007

(54) Partially coherent transmission for a multi-carrier communication system

(76) Inventors: Mansoor Ahmed, Fort Worth, TX (US); Zhijun Cai, Euless, TX (US); Robert M. Harrison, Grapevine, TX (US)

Correspondence Address: MOTOROLA, INC., 1303 EAST ALGONQUIN ROAD, IL01/3RD, SCHAUMBURG, IL, 60196, US

(21) Appl. No.: 11/244,927

(22) Filed: Oct. 6, 2005

(51) Int. Cl. H04J 11/00

(52) U.S. Cl. 370/203

(57) ABSTRACT

A method and apparatus for performing partially coherent Multiple Input Multiple Output (MIMO) transmissions within a multi-carrier communication system is provided herein. During operation similar information bits enter each base station (401, 402). The information bits are encoded by each base station to produce a plurality of systematic bits and parity check bits. Each base station produces a set of similar systematic/parity bits and dissimilar systematic/parity bits. The similar bits are modulated and transmitted using the same resource elements. The remaining symbols are transmitted on any resource elements. Thus the transmissions from multiple base stations are received by the UE partially coherently. Since the same fraction of systematic bits are transmitted from each base station, the transmissions are homogeneous and hence can be received and decoded equally well in any cell are outside the handover region (i.e. closer to base station).

### FIELD OF THE INVENTION

The present invention relates generally to multi-carrier communication systems and in particular, to a method and apparatus for performing partially coherent Multiple Input Multiple Output (MIMO) transmissions within such multi-carrier communication systems.

### BACKGROUND OF THE INVENTION

It is generally accepted that a multi-carrier transmission scheme such as Orthogonal Frequency Division Multiplexing (OFDM) is likely to be the technology of choice for many next-generation communication systems. Such next-generation communication systems will need to enable high data rates for multimedia broadcast/multicast services (MBMS). OFDM has been proposed in a simulcast environment for MBMS services. In such prior art solutions, as long as the same resource elements (e.g., sub-channels) are employed by the base stations, the user equipment (UE) experiences the diversity and power gain provided by the multiple base stations without expending additional resources such as RAKE fingers etc.

While simulcast OFDM performs well in low coding rate situations, e.g. R=¼ wherein the codec provides the frequency diversity, at high code rates (R=¾) the frequency diversity accorded by the decoder quickly disappears. At the fringe of the cell, providing better coding (lower rates) will improve the MBMS capacity significantly while providing adequate service to UEs closer to the base stations. In other words, lower coding rates (and hence higher coding gains) are more important at the edge (fringe) of the cell than at locations closer to the base station. Thus, an optimal system would provide higher coding gains at the cell edges (through lower coding) without bandwidth expansion. Therefore, a need exists for a method and apparatus for providing higher coding gains at the cell edges (through lower coding) without bandwidth expansion.

### BRIEF DESCRIPTION OF THE DRAWINGS

FIG. 1 is a block diagram of a communication system.

FIG. 2 illustrates division of a wideband channel into many narrow frequency bands (sub-carriers).

FIG. 3 illustrates transmission from multiple base stations utilizing a partially coherent transmission scheme.

FIG. 4 is a block diagram of multiple base stations utilizing a partially coherent transmission scheme.

FIG. 5 is a block diagram of User Equipment.

FIG. 6 is a flow chart showing operation of a base station.

FIG. 7 is a flow chart showing operation of user equipment.

### DETAILED DESCRIPTION OF THE DRAWINGS

In order to address the above-mentioned need, a method and apparatus for performing partially coherent MIMO transmissions within a multi-carrier communication system is provided herein. During operation similar information bits enter each base station. The information bits are encoded by each base station to produce a plurality of systematic bits and parity check bits. Each base station produces a set of similar systematic/parity bits and dissimilar systematic/parity bits. The common bits are modulated and transmitted using the same resource elements. The remaining symbols are transmitted on any resource elements. Thus the transmissions from multiple base stations are received by the UE in a partially coherent fashion. Since the same fraction of systematic bits are transmitted from each base station, the transmissions are homogeneous and hence can be received and decoded equally well in any cell are outside the handover region.

The present invention encompasses a method for a base station to perform partially coherent transmission within a multi-carrier communication system. The method comprises the steps of receiving a plurality of information bits, encoding the information bits to produce a plurality of systematic bits and a plurality of parity bits, and classifying bits from the plurality of systematic bits and the plurality of parity bits as either common or differing systematic or parity bits. The common and differing systematic and parity bits are transmitted as common symbols and differing symbols within the multi-carrier communication system. The common symbols are transmitted by at least one other base station.

The present invention additionally encompasses a method for receiving a partially coherent transmission within a multi-carrier communication system. The method comprises the steps of receiving transmissions from multiple base stations. The transmissions contain commonly transmitted symbols received from multiple base stations on a first plurality of subcarriers and differing symbols received from multiple base stations on a second plurality of subcarriers. A group of common systematic and parity bits are produced from the common symbols and a group of differing systematic and parity bits are produced from the differing symbols. The common and differing systematic and parity bits are combined to produce a bit stream and the bit stream is decoded.

The present invention additionally encompasses an apparatus for performing partially coherent transmission within a multi-carrier communication system. The apparatus comprises an encoder receiving a plurality of information bits and encoding the information bits to produce a plurality of systematic bits and a plurality of parity bits. The apparatus additionally encompasses a classifier classifying bits from the plurality of systematic and parity bits as either common or differing systematic or parity bits. Grouping circuitry is provided for grouping the common and the differing systematic and parity bits. Finally, the apparatus comprises a transmitter for transmitting the common and differing systematic and parity bits as common symbols and differing symbols within the multi-carrier communication system.

The present invention encompasses an apparatus for receiving a partially coherent transmission within a multi-carrier communication system. The apparatus comprises a classifier receiving transmissions from multiple base stations, the transmissions comprising commonly transmitted symbols received from multiple base stations on a first plurality of subcarriers and differing symbols received from multiple base stations on a second plurality of subcarriers. A first receiver is provided for producing common systematic and parity bits from the common symbols, and at least a second receiver is provided for producing differing systematic and parity bits from the differing symbols. A combiner combines the common and differing systematic and parity bits to produce a bit stream. A decoder decodes the bit stream.

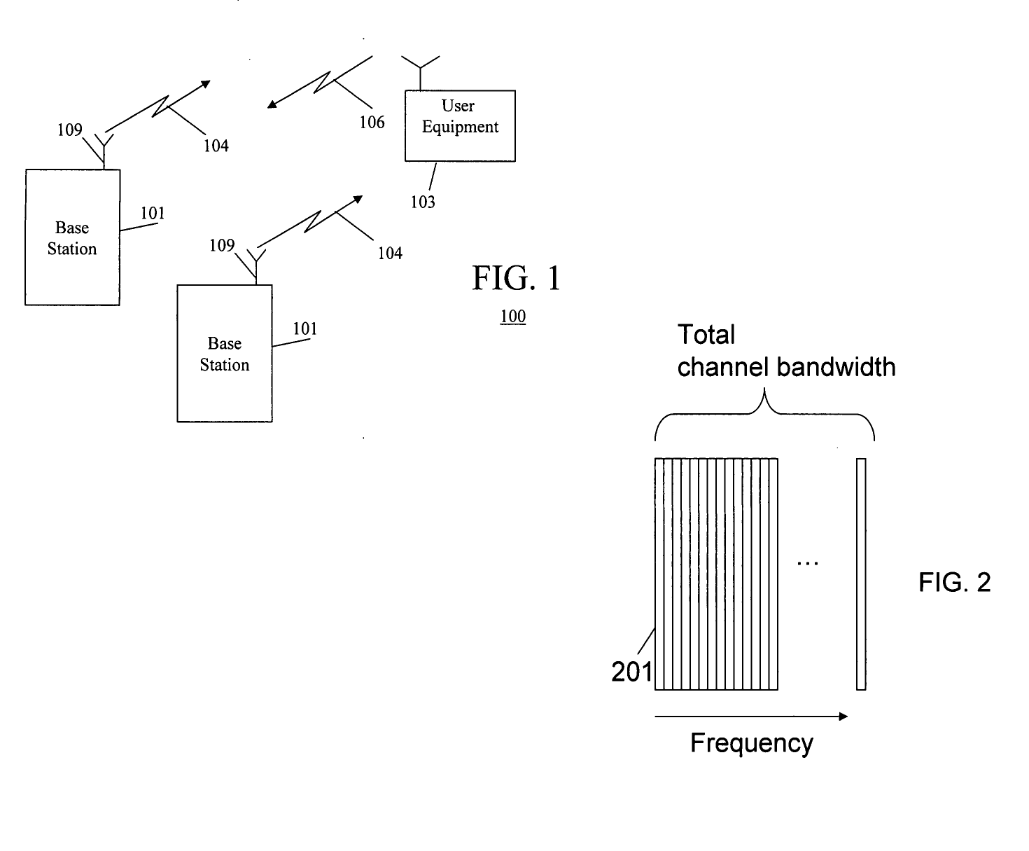

Turning now to the drawings, where like numerals designate like components, FIG. 1 is a block diagram of communication system 100. Communication system 100 utilizes a next generation OFDM or multicarrier based architecture. The architecture may also include the use of spreading techniques such as Multi-Carrier Code Division Multiple Access (MC-CDMA), Multi-Carrier Direct Sequence CDMA (MC-DS-CDMA), Orthogonal Frequency and Code Division Multiplexing (OFCDM) with one or two dimensional spreading, or may be based on simpler time and/or frequency division multiplexing/multiple access techniques, or a combination of these various techniques. In alternate embodiments communication system 100 may utilize other wideband cellular communication system protocols such as, but not limited to, Time Division Multiple Access (TDMA) or direct sequence CDMA.

As one of ordinary skill in the art will recognize, during operation of an OFDM system, multiple sub-carriers (e.g., 768, sub-carriers) are utilized to transmit wideband data. This is illustrated in FIG. 2. As shown in FIG. 2 the wideband channel is divided into many narrow frequency bands (sub-carriers) 201, with data being transmitted by multiple base stations 101 to user equipment 103 on sub-carriers 201.

Returning to FIG. 1, communication system 100 includes base stations 101 and user equipment 103. User Equipment 103 may also be referred to as a communication unit, remote unit, or simply a mobile, while a base station 101 may also be referred to as a communication unit, access point, node, or simply Node-B. Base stations 101 comprise a transmitter and receiver that serve a number of remote units within a sector. As known in the art, the entire physical area served by the communication network may be divided into cells, and each cell may comprise one or more sectors. Base stations 101 may employ multiple antennas 109 to serve each sector in order to provide various advanced communication modes (e.g., adaptive beam forming, transmit diversity, transmit Spatial Division Multiple Access (SDMA), multiple stream transmission, etc.). Base stations 101 transmit downlink communication signals 104 to user equipment 103 on at least a portion of the same resources (time, frequency, or both). User equipment 103 communicates with base stations 101 via uplink communication signal 106.

It should be noted that while only two base stations and a single UE 103 are illustrated in FIG. 1, one of ordinary skill in the art will recognize that typical communication systems comprise many base stations in simultaneous communication with many UEs 103. It should also be noted that while the present invention is described primarily for the case of downlink transmission from one base unit to multiple remote units for simplicity, the invention is also applicable to uplink transmissions from the UE to the multiple base stations.

In the macro-MIMO sense, the data rates supported at the fringe of a cell is increased by transmitting identical distinct portions of the user data from multiple cells. Because cells are transmitting identical distinct portions, UEs at the cell edges can benefit from diversity gains, with the channel encoding being performed on identical pieces of the data transmitted from the multiple base stations. The traditional sense of macro-MIMO leads one to believe that the data rates supported at the cell fringe is equalized with the data rate toward the cell center by providing multiple physical channels to the UE at the cell fringe. However, one may employ the macro-MIMO streams to enhance coding gain for the same data.

An optimal system provides higher coding gains at the cell edges (through lower coding) without bandwidth expansion. In order to accomplish this, a method and apparatus for performing partially coherent transmissions within a multi-carrier communication system is provided herein. More particularly, partially coherent transmission can be achieved through incrementally redundant transmissions from multiple base stations. A mechanism which transmits different code bits for the same set of information bits, i.e. spatial incremental redundancy is utilized. The transmissions from the multiple base stations are homogenous in terms of the total bits transmitted, thus UEs in each cell can decode the information given adequate SINR from the transmissions of just that cell. At the cell edge (in soft handover region) the UE receives more code bits and hence its performance improves.

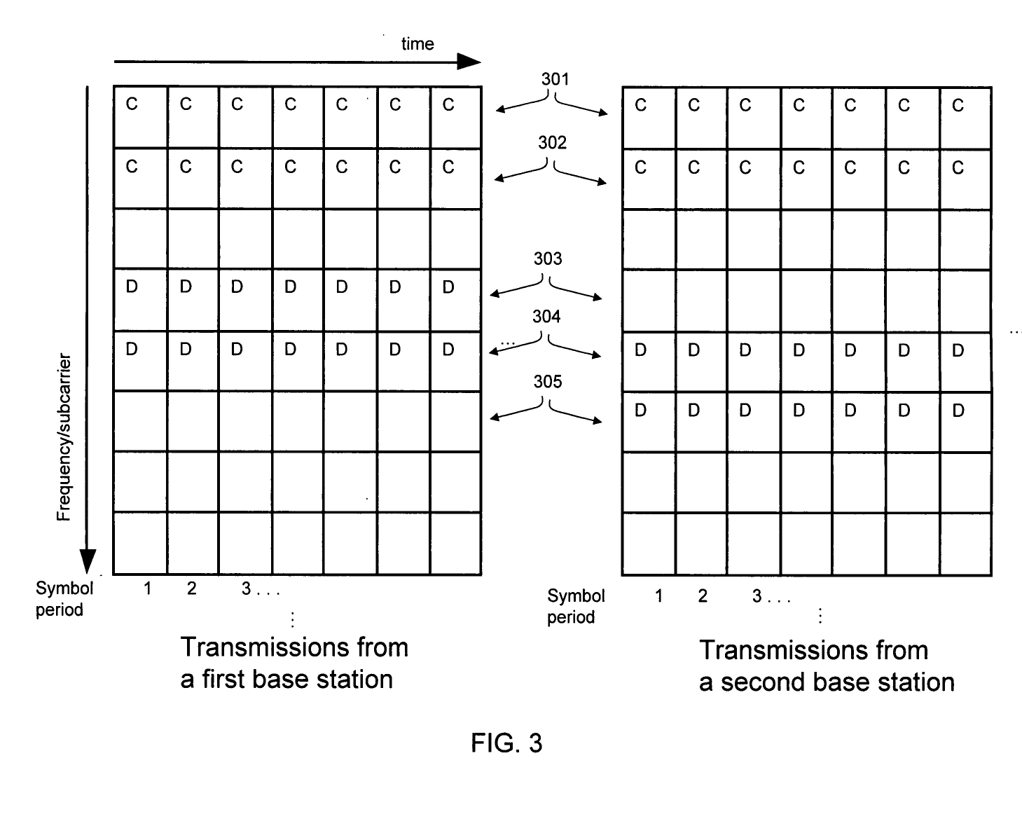

FIG. 3 illustrates transmission from multiple base stations utilizing a partially coherent macro-MIMO transmission scheme. Unlike the prior art, where all sub-carriers transmitted from each base station contain the same (identical) symbols, some of the sub-carriers contain differently encoded symbols even though the information sources are identical. In other words, each base station receives the same information bits with the same information bits being coded with different redundancy versions by each base station. This results in some symbols being identical from each base station and other symbols being different. The identical symbols are transmitted using the same resource elements (sub-carriers, time, and hopping patterns). The differing symbols can be transmitted on any resource elements. During reception, the identical sub-carriers can be combined “coherently over the air” as normal OFDM symbols, and the remainder are explicitly combined by computing LLRs for symbols from each base station.

In FIG. 3 the identical bits/symbols are identified as a “common bit set” C, and the different bits as “different bit set” D. Thus, FIG. 3 illustrates common symbols being transmitted on sub-carriers 301 and 302, with the different symbols being transmitted on sub-carriers 303-305. More specifically, common symbols transmitted from a first base station and a second base station utilizes sub-carriers 301-302. The first base station utilizes sub-carriers 303 and 304 for transmitting differing symbols. The second base station utilizes sub-carriers 304 and 305 for transmitting the differing symbols.

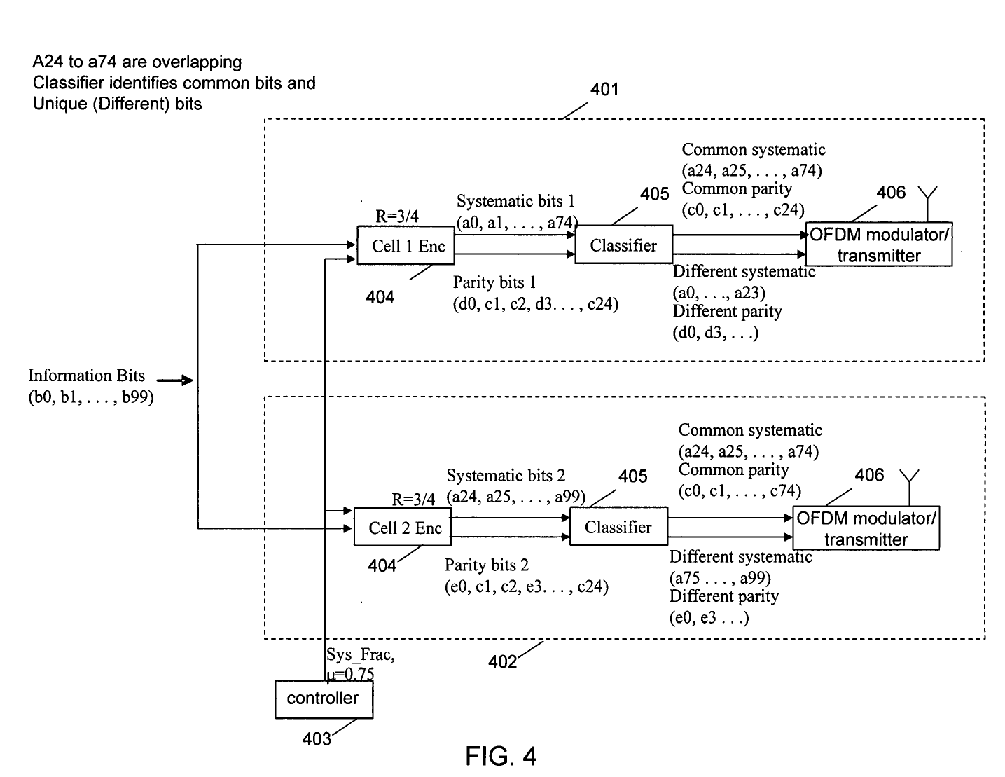

FIG. 4 is a more-detailed block diagram of two base stations 401 and 402 performing partially coherent macro-MIMO transmission within a multi-carrier communication system. As shown, each base station 401, 402 comprises encoder 404, classifier 405, and OFDM modulator 406. During operation similar information bits (b₀, b₁, . . . b₉₉) enter each base station 401, 402 and are properly encoded by encoders 404. More particularly, encoders 404 receive data and use turbo codes (or Low-Density-Parity-Check codes, Reed-Solomon or any other code) to generate systematic and parity bits. Multiple coding rates (e.g., R=¼, R=½, R=⅔, . . . , etc.) may be available to provide optimal data rates based on the transmitted signal characteristics.

Once the data has been encoded, a plurality of systematic bits and parity check bits are output by encoders 404. However, encoders 404 are instructed to pass on only certain systematic bits and parity check bits. More particularly, controller 403 instructs encoders 404 to pass on only a fraction (μ) of their systematic bits. The controller 403 may be located at a base station, at a radio network controller, at a multicast transmissions server, and/or may be distributed throughout various resources on the communication system 100. Given an (n, k) code (i.e. Rate=k/n), each base station transmits μk systematic bits and n-μk parity bits. Of the μk systematic bits and n-μk parity bits, some will be similar and some will be differing. Of course the systematic and parity portions are themselves not identical from the different base stations. Thus if μk systematic bits are transmitted from each base station, a portion of them are common (among all base stations) and the remaining are different. Similarly, the parity bits can be classified as common and different.

Parity bits and systematic bits enter classifier 405, with classifier 405 classifying which bits are similar and which bits are differing. As an example, base station 401 outputs systematic bits (a₀, a₁, . . . a₇₄) and base station 402 outputs systematic bits (a₂₄, a₂₅, . . . a₉₉). Similarly, base station 401 outputs parity bits (d₀, c₁, c₂, d₃. , . . C₂₄) and base station 402 outputs parity bits (e₀, c₁, C₂, e₃., . . c₂₄). As is evident, systematic bits a₂₄ through a₇₄, are similar and systematic bits a₀ through a₂₃ and a₇₅ through a₉₉ are differing. Similarly, parity bits c₀ to c₂₄ are similar and parity bits d₀, e₀, d₃, e₃, . . . , d₂₄, e₂₄, are differing.

Classifier 405 outputs two streams of data, namely a first stream with common systematic and common parity bits, and a second stream of differing systematic and differing parity bits. OFDM modulators 406 receive these streams and modulate the bits to produce the modulated symbol streams shown in FIG. 3. More particularly, the bit streams enter modulators 406 and are appropriately OFDM modulated to produce symbol streams at various sub-carriers, i.e. the two bit streams (common and differing) are, for example MQAM/MPSK modulated separately and then an inverse fast Fourier transform (IFFT) is computed. Any channel interleaving has to be performed separately for the various streams.

Because a common bit stream and a differing bit stream enter OFDM modulators 406, modulators 406 will produce a common symbol stream and a differing symbol stream from the bits. As discussed, it is optimal for the common bits/symbols to occupy the same sub-carriers so that they can be received as a single transmission and coherently combined without cross interference between base stations for those bits. Thus, these common bits are modulated and transmitted using the same resource elements. The remaining symbols can be transmitted on any resource elements. Thus the transmissions from multiple base stations are received by the UE partially coherently. Since the same fraction of systematic bits are transmitted from each base station, the transmissions are homogeneous and hence can be received and decoded equally well in any cell outside the handover region (i.e. closer to base station).

Of course, the UE and base stations must know which parity and systematic bits are transmitted from the various base stations. This can be achieved by receiving information indicating which encoded bits are common and differing through appropriate signaling from a common controller. Thus UEs and base stations receive the information from controller 403. Controller 403 may be a stand-alone entity within communication system 100, or alternatively may be incorporated into a base station. Controller 403 provides signaling that is needed to indicate which systematic and parity bits are transmitted from each cell. The common bits and the different bits are pre-defined by controller 403 into multiple Distribution Versions (DVs). Over the neighbor cell radio bearer information message, the index of the DV for each neighboring cell is signaled (the index of the DV for the serving cell is signaled in the current cell radio bearer information message). The UE can utilize the DVs from the neighboring cells to perform the combining and decoding. A pre-defined DV may be transmitted over a control channel. Default DVs can also be defined to further reduce the complexity. DVs with mutually exclusive systematic bits result in a transmission that can be easily identified as macro-MIMO.

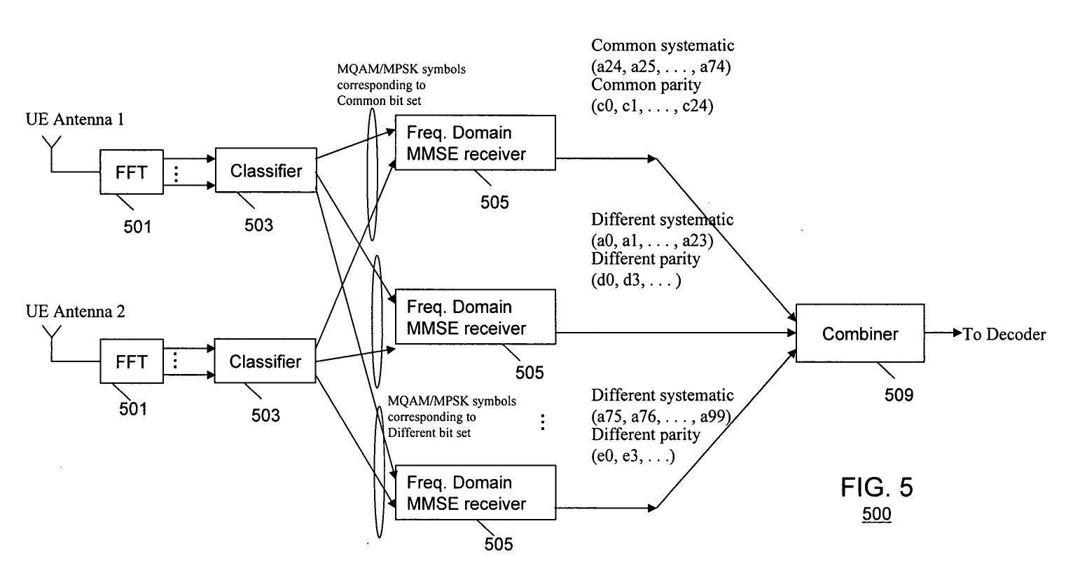

FIG. 5 is a block diagram of User Equipment 500. As shown, UE 500 comprises a plurality of fast Fourier transform (FFT) circuitry 501, classifying circuitry 503, receiver circuitry 505, and a combiner 509. During operation, each antenna branch performs a FFT operation on the received over-the-air transmission and outputs the multiple subcarriers to classifier 503. Classifier 503 identifies the subcarriers as containing either common transmissions (symbols), or differing transmissions. All common transmissions are sent to a single receiver 505 (e.g., an MMSE receiver or a RAKE receiver), while the differing subcarriers are sent to a receiver 505 for each base station. Common systematic and parity bits are produced from a first receiver and differing systematic and parity bits are produced from at least a second receiver. Thus, FIG. 5 shows two base stations transmitting differing systematic and parity bits, with the common subcarriers being sent to a first receiver and the differing subcarriers being sent to other receivers. The outputs of the receiver comprise systematic and parity bits that are based on the log-likelihood ratio (LLR) of the corresponding symbol. Thus, the output of a first receiver comprises common systematic and parity bits, while the output of at least a second receiver comprises differing systematic and parity bits. All systematic and parity bits are output to combiner 509 where they are properly combined to produce a single bit stream for decoding. A decoder (not shown) then decodes the bit stream.

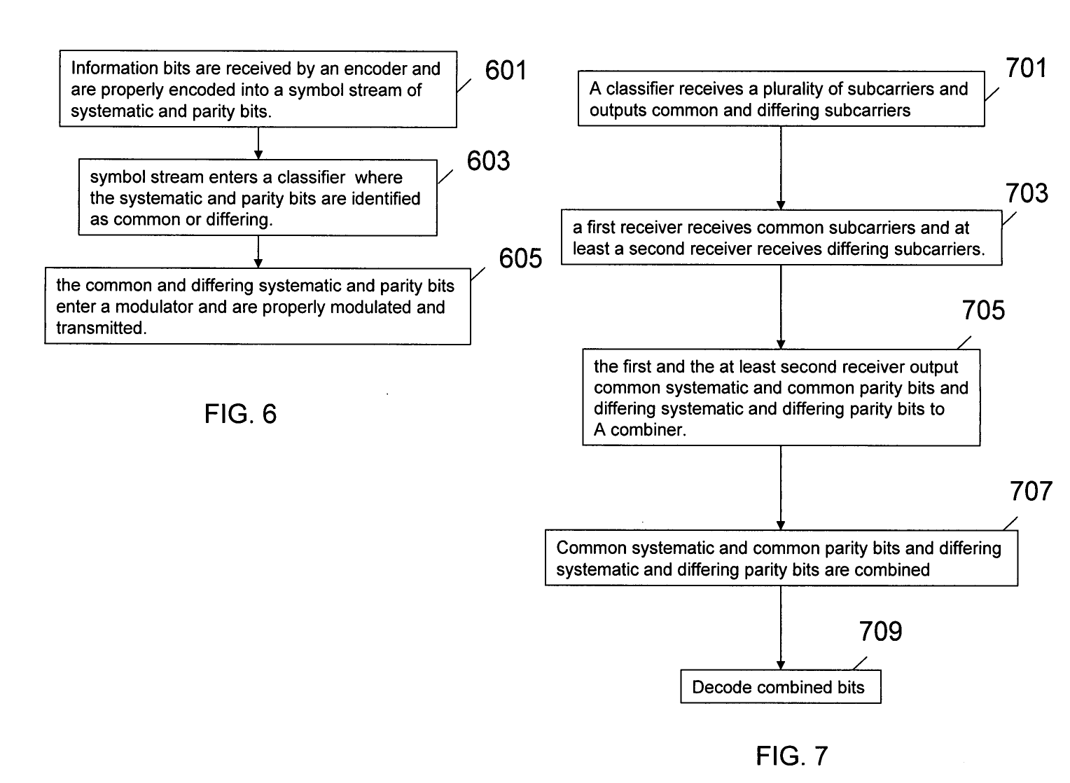

FIG. 6 is a flow chart showing operation of a base station of FIG. 4. The logic flow begins at step 601 where information bits are received by encoder 404 and are properly encoded into a plurality of encoded bits (i.e., systematic and parity bits). At step 603 the stream of encoded bits enters classifier 405 where the encoded bits are classified as common or differing. As discussed above, common bits are those bits that are identical to bits being transmitted on another transmitter (i.e., base station, base station sector, . . . , etc.) while differing bits are bits that differ from those that are being transmitted on other transmitter (i.e., they are unique to the particular base station transmitting them). All bits can be destined to a single or multiple UEs.

Continuing, at step 605 the common and differing encoded bits enter OFDM modulator 406 and are properly modulated to produce common and differing symbols determined from the common and differing bits. The common and differing encoded bits are then transmitted as common and differing symbols. Common symbols are transmitted by at least one other transmitter (base station or base station sector) within the communication system and differing symbols are not transmitted by another transmitter within the communication system.

As discussed above, after modulation common symbols are transmitted on identical resource elements (i.e., identical subcarriers used among all transmitters transmitting the common symbols). Thus, all base stations transmitting the common symbols will utilize the same subcarriers for transmission. Additionally, differing symbols will be transmitted on differing subcarriers. In the preferred embodiment of the present invention at least one other base station transmits the common symbols. Thus, the step of transmitting the common symbols comprises the step of transmitting the common symbols on a first plurality of resource elements (e.g., subcarriers), wherein the first plurality of resource elements are used to transmit the common symbols from other base stations. A second plurality of resource elements are used to transmit the differing symbols.

FIG. 7 is a flow chart showing operation of user equipment. The logic flow begins at step 701 where classifier 503 receives a plurality of subcarriers and outputs common and differing subcarriers. As discussed above, commonly transmitted symbols are received from multiple base stations on a first plurality of subcarriers and differing symbols received from multiple base stations are received on a second plurality of subcarriers. Additionally information may be received describing which parity and systematic bits are transmitted from the various base stations. At step 703 a first receiver receives common subcarriers and at least a second receiver receives differing subcarriers. A group of common encoded bits are produced form the common symbols and a group of differing encoded bits are produced from the differing symbols. At step 705 the first and the at least second receivers output common and differing encoded bits based on the LLRs of the received symbols, where they are properly combined (step 707) and decoded (step 709).

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for a base station to perform partially coherent transmission within a communication system, the method comprising the steps of:
receiving a plurality of information bits;
encoding the information bits to produce a plurality of encoded bits;
classifying bits from the plurality of encoded bits as either common or differing bits;
transmitting common symbols determined from the common bits, wherein the common symbols are transmitted by at least one other transmitter within the communication system; and
transmitting differing symbols determined from the differing bits, wherein the differing symbols are not transmitted by another transmitter within the communication system.

2. The method of claim 1 wherein the step of encoding further comprises the step of encoding the information bits to produce a plurality of systematic and parity bits and further comprising the step of:
receiving information indicating which encoded bits are common and differing.

3. The method of claim 1 wherein the step of transmitting the common symbols comprises the step of transmitting the common symbols on resource elements used by the at least one other transmitter to transmit the common symbols.

4. The method of claim 1 wherein the information bits are the same at the base station transmitter and the other transmitter.

5. The method of claim 1 wherein the step of transmitting the common symbols comprises the step of transmitting the common symbols on a first plurality of subcarriers, wherein the first plurality of subcarriers are used to transmit the common symbols from the at least one other transmitter.

6. The method of claim 1 wherein the step of transmitting the common and differing symbols comprises the step of transmitting the common symbols on a first plurality of subcarriers and transmitting the differing symbols on a second plurality of subcarriers, wherein the first plurality of subcarriers are used to transmit the common symbols from the at least one other transmitter.

7. The method of claim 1 further comprising the step of
transmitting information indicating which encoded bits are common and differing.

8. The method of claim 7, where the information is transmitted on a third transmitter.

9. The method of claim 1 wherein the at least one other transmitter comprises at least one other transmitter from another base station.

10. The method of claim 1 wherein the at least one other transmitter comprises at least one other transmitter from another sector within the base station.

11. A method for receiving a partially coherent transmission within a communication system, the method comprising the steps of:
receiving transmissions from multiple base stations, the transmissions comprising commonly transmitted symbols received from multiple base stations on a first plurality of subcarriers and differing symbols received from multiple base stations on a second plurality of subcarriers;
producing a group of common systematic and parity bits from the common symbols;
producing a group of differing systematic and parity bits from the differing symbols;
combining the common and differing systematic and parity bits to produce a bit stream; and
decoding the bit stream.

12. The method of claim 11 further comprising the step of:
receiving information indicating which symbols are common and differing.

13. An apparatus for performing partially coherent transmission within a multi-carrier communication system, the apparatus comprising:
an encoder receiving a plurality of information bits and encoding the information bits to produce a plurality of encoded bits;
a classifier classifying bits from the plurality of encoded bits as either common or differing encoded bits and grouping the common and the differing encoded bits to produce a group of common encoded bits and a group of differing encoded bits;
a transmitter transmitting common symbols determined from the common bits, wherein the common symbols are transmitted by at least one other transmitter within the communication system; and
a transmitter transmitting differing symbols determined from the differing bits, wherein the differing symbols are not transmitted by another transmitter within the communication system.

14. The apparatus of claim 13 wherein a first plurality of resource elements are used to transmit the common symbols from the transmitter and the at least one other transmitter.

15. The apparatus of claim 13 wherein a first plurality of subcarriers is used to transmit the common symbols from the transmitter and the at least one other transmitter.

16. The apparatus of claim 13 wherein the common symbols are transmitted on a first plurality of subcarriers and the differing symbols are transmitted on a second plurality of subcarriers, and the first plurality of subcarriers are used to transmit the common symbols from the at least one other transmitter.

17. An apparatus for receiving a partially coherent transmission within a multi-carrier communication system, the apparatus comprising:
a classifier receiving transmissions from multiple base stations, the transmissions comprising commonly transmitted symbols received from multiple base stations on a first plurality of subcarriers and differing symbols received from multiple base stations on a second plurality of subcarriers;
a first receiver producing common systematic and parity bits from the common symbols;
a second receiver producing differing systematic and parity bits from the differing symbols;
a combiner combining the common and differing systematic and parity bits to produce a bit stream; and
a decoder decoding the bit stream.
